(19) United States
(12) Patent Application Publication
(10) Pub. No.: US 2002/0055977 A1
(43) Pub. Date: May 9, 2002

(54) Remote control system

(75) Inventor: Yosuke Nishi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Yamatake Corporation, Tokyo (JP)

(21) Appl. No.: 09/986,283

(22) Filed: Nov. 8, 2001

(30) Foreign Application Priority Data
Nov. 9, 2000 (JP) 2000-341270
Oct. 18, 2001 (JP) 2001-320121

(51) Int. Cl. G06F 15/16

(52) U.S. Cl. 709/208; 709/225

(57) ABSTRACT

A remote control system is provided to control remotely electronic equipment connected via a firewall to an external network. The remote control system have command information memory for storing command information transmitted from a user terminal via the external network. Further, command information transmission means is provided to receive a command fetch request transmitted from the electronic equipment via the external network and to read out command information corresponding to that request from the command information memory, and to transmit the command information via the external network to the electronic equipment as a response to that command fetch request.

### BACKGROUND OF THE INVENTION

1. Field of the Invention

This invention relates to a remote control system for remotely controlling electronic equipment, and more particularly to a remote control system for remotely controlling electronic equipment connected through a firewall to an external network.

2. Description of the Related Art

Technology is recently being proposed wherewith, in the ordinary home, common electronic equipment such as lights, television receivers (TVs), video decks, air conditioners (air conditioning equipment), personal computers (PCs), motorized curtains, security equipment, hot water supply systems and audio products are connected in a network by communication lines, and such operations as turning switches off that one has forgotten to turn off, turning on the air conditioner prior to returning home, or heating the bath water, are performed by remote control from the work place or other location outside the home. Technology is also being proposed wherewith, in like manner, the lighting of common-use space in collective dwellings and such electronic equipment as various kinds of security equipment therein are connected in a network by communication lines and remotely controlled.

The internet is a conceivable network for use in effecting remote control. The internet is outstanding in that it is a global network and in that therewith indeterminate opposite parties can be communicated with throughout the world, but poses security problems because it is an open network. For that reason, when building an internal network that is to be connected to the internet, a firewall (FW) is commonly placed between the internet and the internal network.

A firewall has functions for rejecting the passage of commands from the outside directed to the internal network. For that reason, ordinarily, the various kinds of electronic equipment connected in the internal network cannot be controlled from the outside.

The documents wherein such conventional technology is disclosed includes Japanese Patent Application Laid-Open No. 2000-172597. In that document, technology is disclosed wherewith a communication interface device is provided for controlling and monitoring process control equipment connected to the internet, by a personal computer connected through a firewall to an internal network.

Thus the conventional technology suffers from the following problems.

(1) Depending on the provider, it can be altogether impossible to control electronic equipment on the internal network because no requests from an external network such as the internet are allowed to pass to the internal network.

(2) Depending on the provider, there are cases where requests from an external network such as the internet are allowed to pass to the internal network without limitation. In such cases, security problems arise in the internal network, and it is necessary to put in place some kind of firewall. With an ordinary firewall, settings are made so that, for example, only signals that follow the HTTP protocol can pass, and settings are made so that only responses to requests from the internal network are allowed to pass.

(3) Specialized knowledge is necessary in making firewall settings. Setting changes cannot be made simply by just anyone.

### SUMMARY OF THE INVENTION

In view of the foregoing, it is an object of the present invention to provide a remote control system wherewith electronic equipment connected to an external network such as the internet through a firewall can be easily subjected to remote control.

It is another object of the present invention to provide a remote control system in which command information from the user can be transmitted promptly to the electronic equipment.

It is further object of the present invention to provide a remote control system in which user can promptly receive the execution result at the electronic equipment.

According to one aspect of the present invention, for achieving the above-mentioned objects, there is provided a remote control system for controlling remotely electronic equipment connected via a firewall to an external network comprising command information memory for storing command information transmitted from a user terminal via the external network and command information transmission means for receiving a command fetch request transmitted from the electronic equipment via the external network, reading out command information corresponding to that request from the command information memory, and transmitting the command information via the external network to the electronic equipment as a response to that command fetch request.

Consequently, electronic equipment connected to an external network such as the internet through a firewall can be easily subjected to remote control.

According to another aspect of the present invention, there is provided a remote control system for controlling remotely electronic equipment connected via a firewall to an external network which comprises wait state setting means for receiving a command fetch request from the electronic equipment via the external network, and setting a wait state for that command information and command information transmission means for receiving command information transmitted from a user terminal via the external network, and transmitting that command information to the electronic equipment as a response to the command fetch request.

Consequently, command information from the user can be transmitted promptly to the electronic equipment since the command fetch request is set in the wait state.

According to further aspect of the present invention, there is provided a remote control system having state information memory for receiving and storing state information transmitted from the electronic equipment via the external network and state information transmission means for transmitting state information stored in the state information memory to the user terminal.

Accordingly, the user easily notice the state of the electronic equipment.

The above and further objects and novel features of the invention will more fully appear from the following detailed description when the same is read in connection with the accompanying drawings. It is to be expressly understood, however, that the drawings are for purpose of illustration only and are not intended as a definition of the limits of the invention.

### BRIEF DESCRIPTION OF THE DRAWINGS

FIG. 1 shows a system configuration of a remote control system according to the present invention.

FIG. 2 shows a configuration of a remote control server according to the present invention.

FIG. 3 shows a configuration of a firewall according to the present invention.

FIG. 4 shows an example of a screen display in a remote control system according to the present invention.

FIG. 5 shows examples of information for authentication.

FIG. 6 is a flowchart showing an example of process of a remote control system according to the present invention.

FIG. 7 shows examples of state information according to the present invention.

FIG. 8 shows a example of screen display in a remote control system according to the present invention.

FIG. 9 shows a example of command information according to the present invention.

FIG. 10 is a flowchart showing an example of process of a remote control system according to the present invention.

FIG. 11 is a flowchart showing an example of process of a remote control system according to the present invention.

FIG. 12 is a flowchart showing an example of process of a remote control system according to the present invention.

FIG. 13 is a flowchart showing an example of process of a remote control system according to the present invention.

FIG. 14 is a flowchart showing an example of process of a remote control system according to the present invention.

FIG. 15 is a flowchart showing an example of process of a remote control system according to the present invention.

### DESCRIPTION OF THE PREFERRED EMBODIMENTS

A preferred embodiment of the invention will now be described in detail referring to the accompanying drawings.

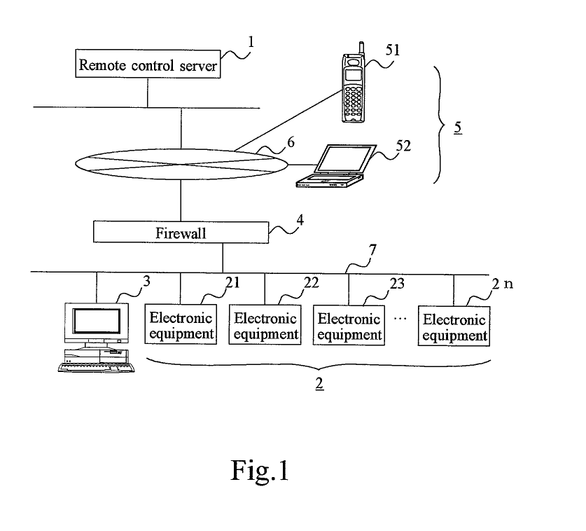

FIG. 1 is a configuration diagram of a remote control system relating to the present invention. In this figure, reference numeral 1 is a remote control server, connected to the internet 6. This remote control server 1 is maintained by an administrator. Reference numeral 2 indicates electronic equipment, there being a plurality of pieces of electronic equipment 21 to 2n mutually connected by an internal network such as a LAN (local area network). Such electronic equipment 2 includes, for example, electronic equipment in the home or in the common-use space of a collective dwelling, such as lights, television receivers, video decks, air conditioners, personal computers (PCs), motorized curtains, hot water supply systems, and audio products, and also includes various kinds of security sensors. The electronic equipment 2 need not necessarily be plural in number, and may be singular. In the latter case, the internal network 7 becomes unnecessary. Reference numeral 3 is a personal computer connected to the internal network 7 to which the electronic equipment 2 is connected. This PC 3 plays such functional roles as fetching state information from the various electronic equipment 2 and transmitting such to the remote control server 1, and receiving requested information for the various electronic equipment 2 from the remote control server 1 and transmitting such to the various electronic equipment 2. This PC 3, in the present invention, plays an auxiliary role. Therefore, there are instances where no mention of the PC 3 is made in the following description, even in cases where information is sent back and forth between the remote control server 1 and the electronic equipment 2 via that PC 3. Furthermore, when the various pieces of electronic equipment 2 communicate with the remote control server 1, this PC 3 is not a mandatory configuration.

Reference numeral 4 is a firewall (FW). The firewall employs various schemes in prohibiting the passage of commands from the outside to the internal network. In the firewall 4 in this embodiment aspect, in particular, however, settings are made so that requests transmitted to the internet 6 from the electronic equipment 2 on the internal network 7, and responses to those requests, are passed, while the passage of all other signals is restricted. Reference numeral 5 indicates such web terminals as a portable telephone 51 (a cellular phone, a mobile phone) and notebook PC 52 capable of being connected to the internet 6. These terminals have browsers loaded in them and are used by users.

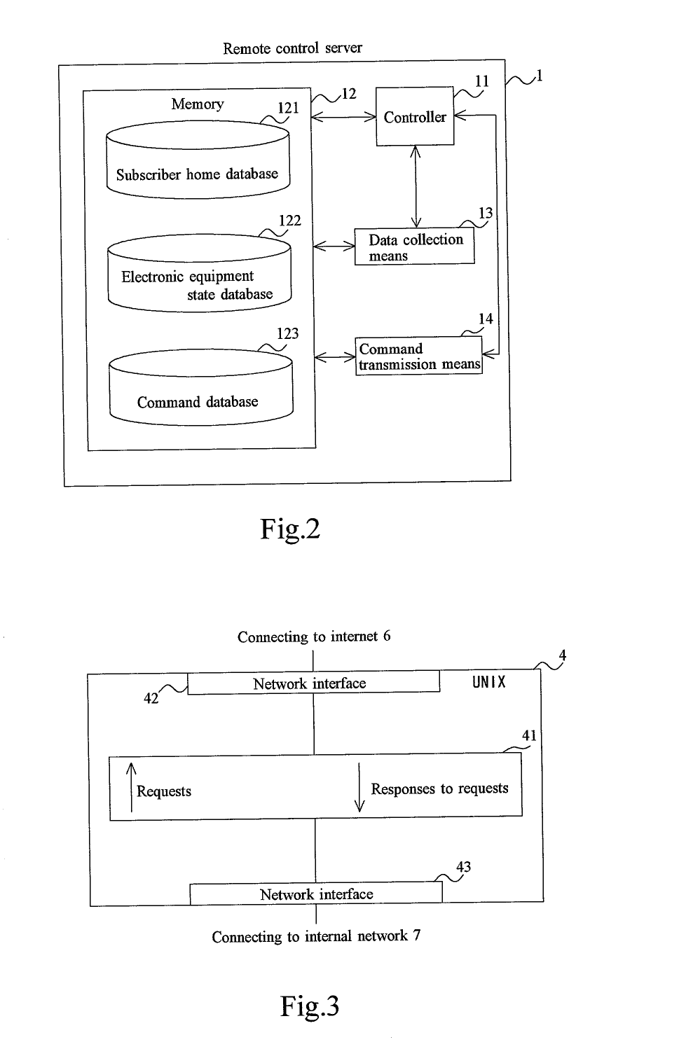

FIG. 2 represents the detailed configuration of the remote control server 1. The remote control server 1 comprises at least a controller 11, memory 12, data collection means 13, and command transmission means 14. The controller 11 is a central processing unit (CPU), for example, which performs processing based on various types of programs (not shown) stored in the memory 12 or the like. The memory 12 has, in addition to those various types of programs, a subscriber home database 121, electronic equipment state database 122, and command database 123. In the subscriber home database 121 are stored user information and information on the electronic equipment 2 that are controlled using a remote control system relating to the present invention, in a condition such that the reading and writing thereof are possible. In the electronic equipment state database 122 are stored state information on the various pieces of electronic equipment 2, in a condition such that the reading and writing thereof are possible. In the command database 123 are stored command information directed toward the electronic equipment 2, transmitted from the web terminals 5 or the like, in a condition such that the reading and writing thereof are possible.

The data collection means 13 has functions for collecting the data stored in the various databases 121, 122, and 123 in the memory 12. The command transmission means 14 has functions for reading out command information from the command database 123 and transmitting such to the electronic equipment 2.

In FIG. 3 is represented an example configuration of the firewall 4. The firewall 4 in this embodiment aspect is connected to the internet 6 by a network interface 42, and is connected to the internal network 7 to which the electronic equipment 2 is connected by a network interface 43. Then, by a filtering unit 41, requests transmitted from the electronic equipment 2 and responses thereto, and only such requests and responses, are passed, while the passage of other signals is restricted.

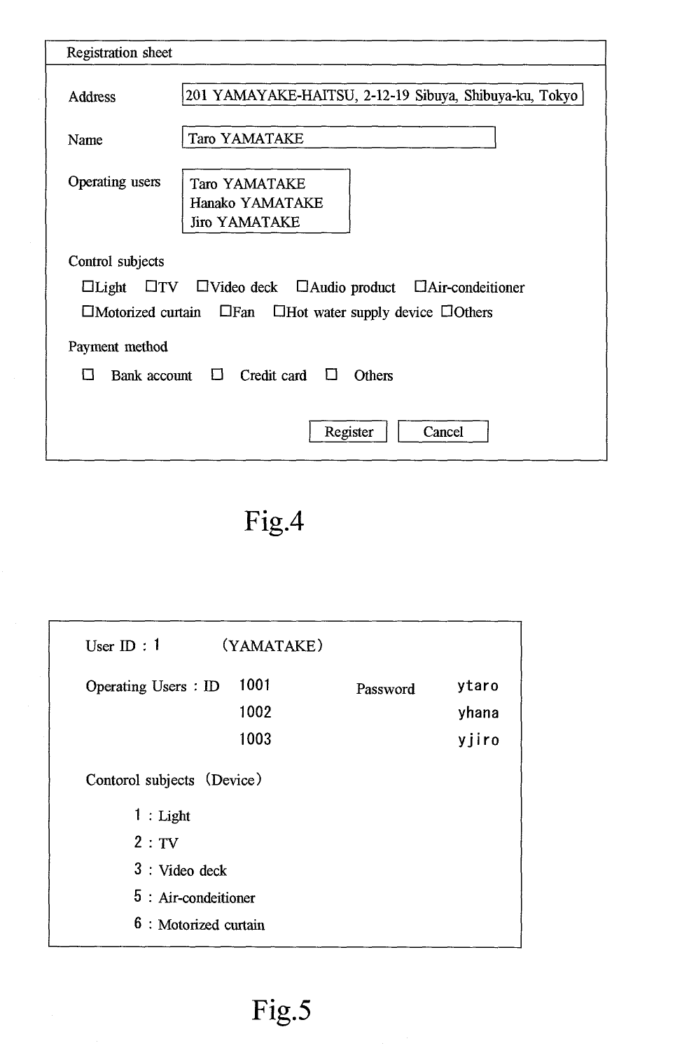

For a user to utilize a remote control system relating to the present invention, it is necessary for that user to effect a user registration beforehand. User registration is described with reference to FIG. 4 and FIG. 5. FIG. 4 shows a registration screen for user registration. The web data relating to this registration screen is either stored in a database (not shown) in the remote control server 1, or stored on a separate web server. When a user accesses the registration screen using his or her own terminal 3 or 5, for example, web data relating to that registration screen are transmitted to the terminal 3 or 5 via the internet 6. The terminal 3 or 5 receives those web data, and displays that registration screen on that display by the browser.

In the example registration screen shown in FIG. 4, messages are displayed which prompt the user to enter the user's address, name, operating users, control subjects, and payment method. Of those, in the box for operating users are entered the names of users who operate the electronic equipment 2 using the external web terminal 5. The electronic mail addresses of these users are also entered on a separate screen. In the box for control subjects, the electronic equipment 2 managed with the use of this remote control server 1 is registered. A check mark is affixed to the electronic equipment 2 which one wishes to register. It is also possible, at the point in time when the user registration is being made, to register definitions of the command information and state information for the various pieces of electronic equipment 2, such as the kind of command information by which the electronic equipment 2 that one wishes to control will operate, or what kind of meaning the state information output is to have. For defining the command information and the state information for the various electronic equipment 2, it is possible for the PC 3 to communicate with the various pieces of electronic equipment 2, obtain such information from the various pieces of electronic equipment 2, and transmit that information to that remote control server 1. Provision may also be made so that individual pieces of the electronic equipment 2 transmit directly to the remote control server 1. After one has finished making entries, in the example registration screen shown in FIG. 4, when the registration button is clicked on, the input information is transmitted via the internet 6 to the remote control server 1.

The remote control server 1 receives that input information and stores it in the subscriber home database 121 in the memory 12. The remote control server 1 also notifies the user making the entries of a user ID, password, and the device numbers of the pieces of electronic equipment 2 that are to be control subjects. That notification may be made by electronic mail or by ordinary mail. When notification is made by electronic mail, for security reasons, it is encrypted and then transmitted. When notification is sent by mail, the various information is printed and then mailed based on the instructions of the operator of the remote control server 1.

FIG. 5 shows examples of such information, that is, of a user ID, password, and control subject equipment information. As indicated in the figure, in the user ID there are both an ID (“1” in this example) that is assigned for each subscribing home, and IDs (“1001,” “1002,” and “1003” in this example) assigned for each operating user. The user enters this user ID and password when verifying state information on the electronic equipment 2 or issuing commands or the like using the web terminal 5. There are also cases where the device number will be entered when confirming state information of specific electronic equipment 2 and making commands.

The processing performed in the remote control system relating to the present invention is described next. With the remote control system relating to the present invention, settings can be altered so that various kinds of processing can be performed. Each of these processes is described below in embodiment aspects 1 to 6 of the invention.

Embodiment Aspect 1 of the Invention

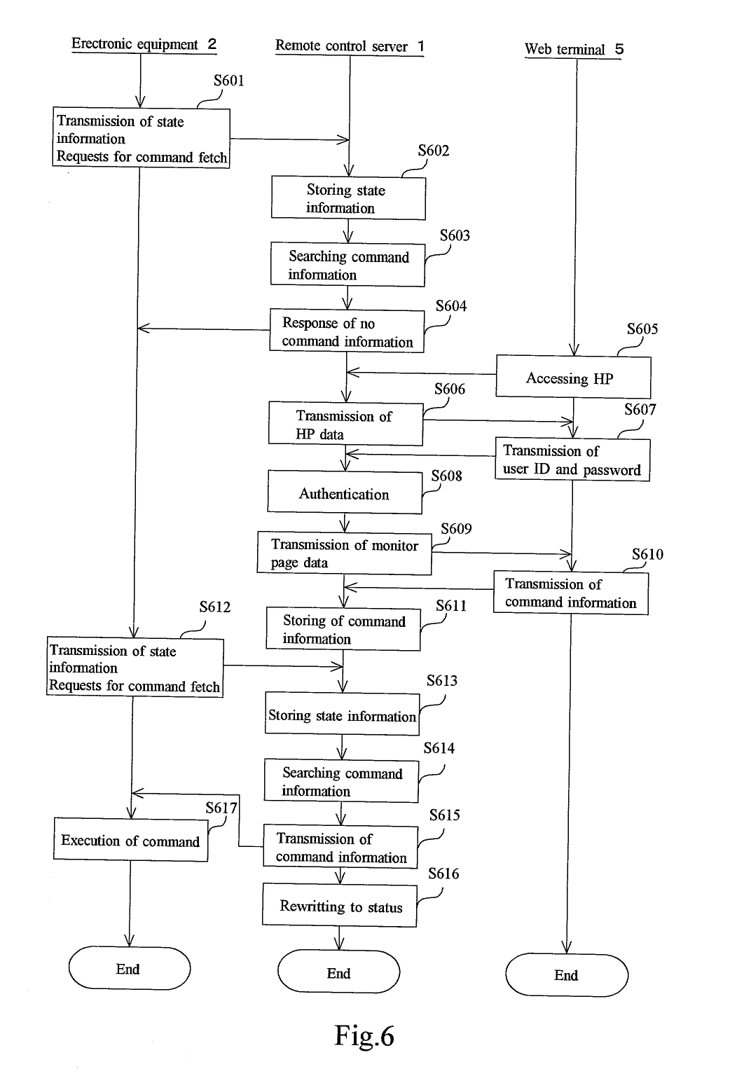

The processing performed in the remote control system relating to this embodiment aspect 1 is described with reference to the flowchart given in FIG. 6.

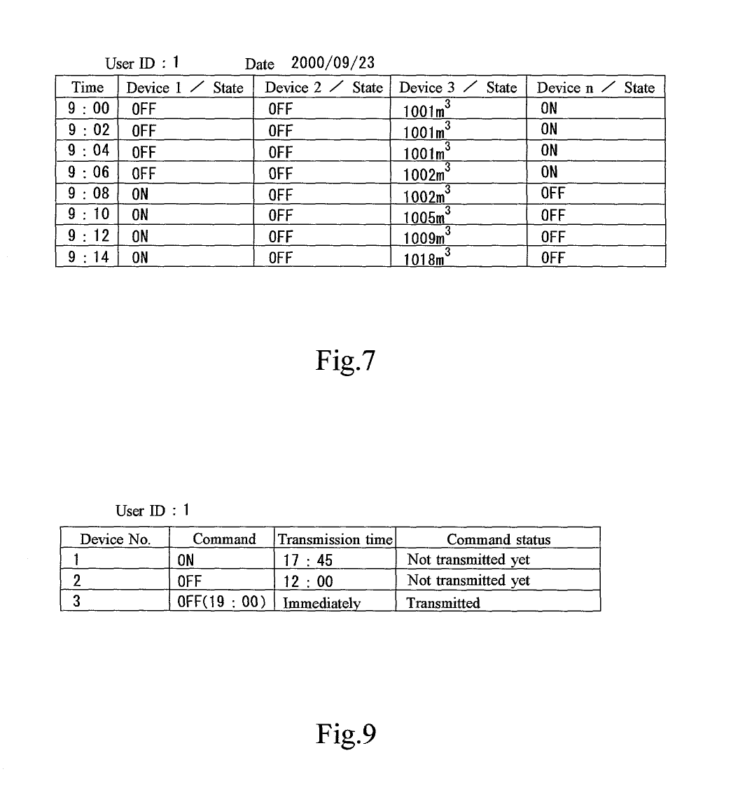

First, from the electronic equipment 2, with predetermined timing, electronic equipment 2 state information and a command fetch request are passed through the firewall 4 via the internal network 7, to the remote control server 1 via the internet 6 (S601). The timing of the transmission of these pieces of information is set in a prescribed program in the electronic equipment 2 or in the PC 3 controlling the electronic equipment 2. The remote control server 1 stores the state information in a prescribed area in the electronic equipment state database 122 by the controller 11 and the data collection means 13 (S602). An example of the information stored in the electronic equipment state database 122 is represented in FIG. 7. In this example, The transmission of state information from the electronic equipment 2 is performed every 2 minutes. For device 1, device 2, and device n, moreover, on-off information is transmitted as state information. For device 3, quantitative information indicating the amount of city water used, for example, is transmitted. This state information contains all kinds of information other than such on-off information and quantitative information, according to the type of electronic equipment 2, such as video information captured by a monitoring camera or information indicating numerically the extent to which an motorized curtain is closed.

Let us return to the flowchart in FIG. 6. The remote control server 1, after the state information has been stored (S602), follows the command fetch request, and the command transmission means 14 retrieves command information for that user from the command database 123 (S603). Let it be assumed that, in this example, there was no command information for that user. In that case, a signal including information indicating that there is no command information is transmitted via the internet 6 or the like to the electronic equipment 2 (S604). At that time, the signal containing that information is a. response to the signal transmitted by step S601, wherefore the firewall 4 can be passed through.

Let it be assumed that, after that, the user wished to operate the electronic equipment 2 in his or her home. First, using the web terminal 5, the user accesses a homepage on this remote control system (S605). The remote control server 1, in response to that access request, reads out HTML data for the designated homepage from the memory 12, and transmits those data to the web terminal 5 via the internet 6 (S606). The web terminal 5 displays that homepage on that display by the browser. The user operates the web terminal 5, and enters and transmits the user ID and password (S607). Authentication information relating to that user ID and password is transmitted to the remote control server 1 via the internet 6. The remote control server 1 receives that authentication information, launches an authentication program, and performs authentication processing (S608). More specifically, information relating to the user ID and information relating to the password stored in the subscriber home database 121 in the memory 12 are referenced, and a decision is made as to whether or not the password is appropriate to the received user ID.

When it has been judged, as a result of the authentication process, that the password is appropriate to the received user ID, monitor page data are transmitted to the web terminal 5 (S609). The web terminal 5 receives those monitor page data and displays them on the display.

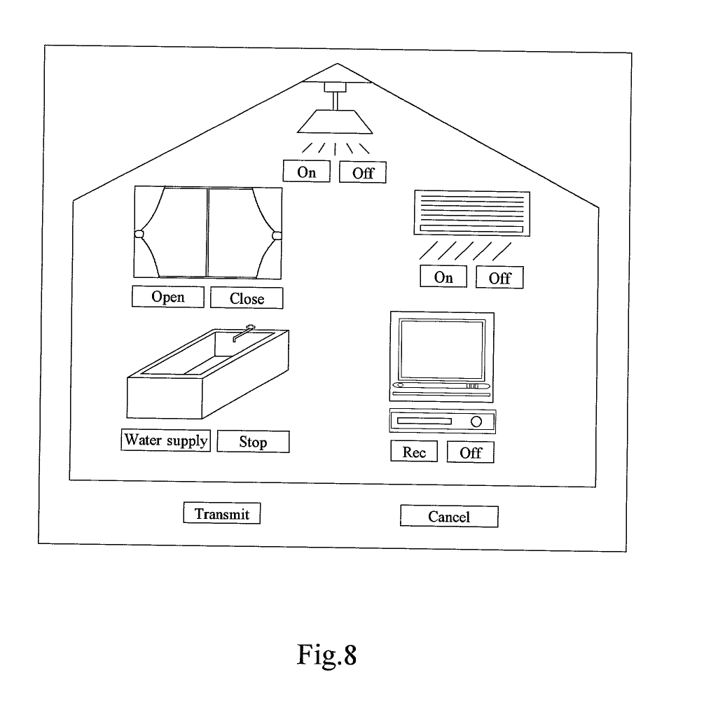

An example screen display of the monitor page data is shown in FIG. 8. In this screen example, five types of electronic equipment 2 are displayed, namely lights, motorized curtain, hot water supply system, air conditioner, and video deck. The state of each is displayed graphically. The lighting is displayed as being turned on, for example, and the condition of the motorized curtain being open is displayed. Below the display of each type of electronic equipment 2, buttons for entering command information are displayed. For the lights, for example, a button labeled “on” and a button labeled “off” are displayed. When the user clicks on the button labeled “off,” it is deemed that a selection has been made to turn the lights off, and a display to that effect is made. The display to that effect may be made in various ways, such, for example, as by changing the graphic showing the lights turned on to one showing the lights turned off, or by changing the display of the buttons themselves. In the example shown in FIG. 8, moreover, the states are indicated by displaying graphics of the electronic equipment 2, but that poses no limitation, and the display may be made by text or numbers only. For an internet-capable portable telephone, in particular, it is preferable that the display be made by text and numbers only. In this example, furthermore, provision has been made to display the state information and input command information on a single page, but that poses no limitation, and provision may be made so that inputs are made on a separate page. In this example, furthermore, the various pieces of electronic equipment are displayed graphically, but that poses no limitation, and provision may be made so that the display is made by device numbers alone. When the user inputs a command in this manner, and clicks on the transmission button, the command information is transmitted from the web terminal 5 to the remote control server 1 (S610).

The remote control server 1 receives the command information and stores it in memory area assigned to that user in the command database 123 (S611). In FIG. 9 is represented an example of command information stored in the memory area of a specific user in the command database 123. In this example, command information for a user having the user ID “1” is represented, and the user has issued a command to turn on the electronic equipment 2 having the device number 1 at 17:45. A command has also been made to turn off the electronic equipment 2 having the device number 2 at 12:00, and a command has been made to turn off the electronic equipment 2 having the device number 3 at 19:00.

Here, in the electronic equipment 2, depending on the type thereof, there is equipment which has a built-in timer function and there is equipment which does not. If the equipment has a built-in timer function, even if the command is that execution should be effected t hours later, for example, it is only necessary to transmit command information from the remote control server 1 to that electronic equipment 2 beforehand, so that the command will be executed t hours later at the electronic equipment 2 end. With equipment having no built-in timer function, on the other hand, in such a case, that electronic equipment 2 will go ahead and execute the command as soon as the command information is received, and the command cannot be executed t hours later. Thereupon, in this example, provision is made so that, for the electronic equipment 2 having the device number 1 and the electronic equipment 2 having the device number 2, the command information is not transmitted to that electronic equipment 2 until the time for executing the command is reached, but the command information is transmitted to each of those pieces of electronic equipment 2 when the execution time is reached. Thus it becomes possible to effect time control also on electronic equipment 2 having no timer function. In the example represented in FIG. 9, no command information has been transmitted to the electronic equipment 2 having the device numbers 1 and 2 for which the transmission time has not yet arrived, wherefore data are stored to the effect that the command condition (status) is “not transmitted yet.” For the electronic equipment 2 having the device number 3 for which data indicating “immediately” are stored for the transmission time, on the other hand, the command information is transmitted immediately, wherefore data to the effect that the command condition (status) is “transmitted” are stored.

Information on whether or not the individual pieces of electronic equipment 21 to 2n have a timer function is registered beforehand. Accordingly, when command information simply designating a time is sent in from the web terminal 5, the registration data are verified, and a decision is made as to whether the electronic equipment 2 subject to that command has a timer function or not. Provision is made so that, when it has been determined that the equipment does have a timer function, the command is transmitted immediately, and so that, when it has been determined that the equipment does not have a timer function, the command is not transmitted immediately but is rather transmitted at the designated time.

After that, state information on commands regularly executed by the electronic equipment 2 and a command fetch request are transmitted to the remote control server 1 (S612). At the remote control server 1, in the same manner as in steps S602 and S603, the received state information is stored in the electronic equipment state database 122 (S613), and command information retrieval is performed from the command database 123 (S614). At that time, in the command database 123, the command information stored in step S611 is present. Therefore, that command information is read out and transmitted from the remote control server 1 to the electronic equipment 2 (S615). Because this command information transmission is performed as a response to a command fetch request (S612), it can pass through the firewall 4. At the remote control server 1, when transmission of the command information is finished, data on the condition (status) of the command in the command database 123 are rewritten to data indicating “transmitted” (S616). By having that done, redundant transmissions can be prevented. At the electronic equipment 2, that command information is received and the command is executed (S617). In a case where the command to the lights is an OFF command, for example, control is effected so that the lights turn off.

Embodiment Aspect 2 of the Invention

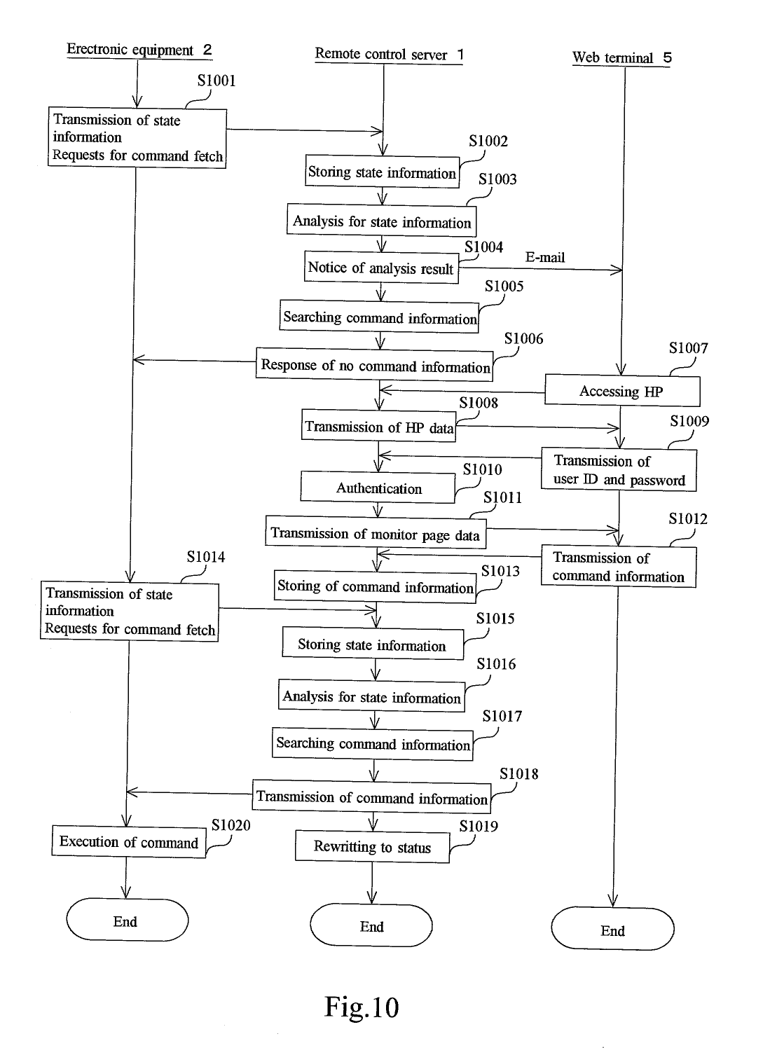

Next, making reference to FIG. 10, processing in the remote control system relating to embodiment aspect 2 is described.

First, from the electronic equipment 2, with prescribed timing, electronic equipment 2 state information and a command fetch request are passed through the firewall 4 via the internal network 7, to the remote control server 1 via the internet 6 (S1001). The remote control server 1 stores the state information in a prescribed area in the electronic equipment state database 122 by the controller 11 and the data collection means 13 (S1002).

Following thereupon, the stored state information is analyzed (S1003). This analysis is performed from the perspective of whether or not the state information contains information indicating a situation where it is urgent that the user be contacted immediately. An investigation is made to determine, for example, whether or not the state information transmitted from security sensors attached to windows or doors contains data that a human intrusion has been sensed, or whether or not the state information transmitted from a gas detecting sensor contains data that a gas leak has been sensed. When, as a result of that analysis, information has been detected indicating a situation where the user should be contacted, notification to that effect is made by electronic mail to the web terminal 5 (S1004). The electronic mail address is obtained from the user information stored in memory in the subscriber home database 121.

Following the command fetch request (S1001), the command transmission means 14 retrieves command information for that user from the command database 123 (S1005). Let it be assumed that, in this example, there was no command information for that user. In that case, a signal containing information to the effect that there is no command information is transmitted to the electronic equipment 2 via the internet 6 (S1006). At this time, because the signal including that information is a response to the signal transmitted by step S1001, the firewall 4 can be passed through.

Let it be assumed that, after that, the user wished to operate the electronic equipment 2 in his or her home. First, using the web terminal 5, the user accesses a homepage on this remote control system (S1007). The remote control server 1, in response to that access request, reads out HTML data for the designated homepage from the memory 12, and transmits those data to the web terminal 5 via the internet 6 (S1008). The web terminal 5 displays that homepage on that display by the browser. The user operates the web terminal 5, and enters and transmits the user ID and password (S1109). Authentication information relating to that user ID and password is transmitted to the remote control server 1 via the internet 6. The remote control server 1 receives that authentication information, launches an authentication program, and performs authentication processing (S1010). When it has been judged, as a result of the authentication process, that the password is appropriate to the received user ID, monitor page data are transmitted to the web terminal 5 (S1011). The web terminal 5 receives those monitor page data and displays them on the display. The display is made as in the screen example shown in FIG. 8. When the user inputs a command and clicks on the transmission button, command information is transmitted from the web terminal 5 to the remote control server 1 (S1012).

The remote control server 1 receives the command information and stores it in memory area assigned to that user in the command database 123 (S1013).

After that, state information on commands regularly executed by the electronic equipment 2 and a command fetch request are transmitted to the remote control server 1 (S1014). At the remote control server 1, the received state information is stored in the electronic equipment state database 122 (S1015). Then the state information is analyzed (S1016). In this case, if the state information transmitted this time (S1014) is the same as the state information transmitted the previous time (S1001), the analysis results will be the same and, therefore, notification will be made to the user, but setting can be made so that redundant notifications are not made. Setting can also be made so that, conversely, the notification will be made even if it is redundant. It is also possible to modify the processing according to the degree of necessity of making notification of the analysis results. More specifically, control can be effected so that notification is made even when it is a redundant notification in cases where the necessity of making the notification is extremely high, such as when a human intrusion from a window has been detected for example, and so that no redundant notification is made in cases where the necessity of making notification is not very high, as when the temperature in a room is slightly high.

Next, command information retrieval is performed from the command database 123 (S1017). At this time, in the command database 123, the command information stored in step S1013 is present. Therefore, that command information is read out and transmitted from the remote control server 1 to the electronic equipment 2 (S1018). Because this command information transmission is performed as a response to a command fetch request (S1014), it can pass through the firewall 4. At the remote control server 1, when transmission of the command information is finished, data on the condition (status) of the command in the command database 123 are rewritten to data indicating “transmitted” (S1019). At the electronic equipment 2, that command information is received, and the command is executed (S1020).

Thus, in the remote control system relating to this embodiment aspect 2, provision is made particularly so that state information is analyzed, and notification of the analysis results is made to the user's terminal, wherefore the user is able to learn of the occurrence of a problem right away.

Embodiment Aspect 3 of the Invention

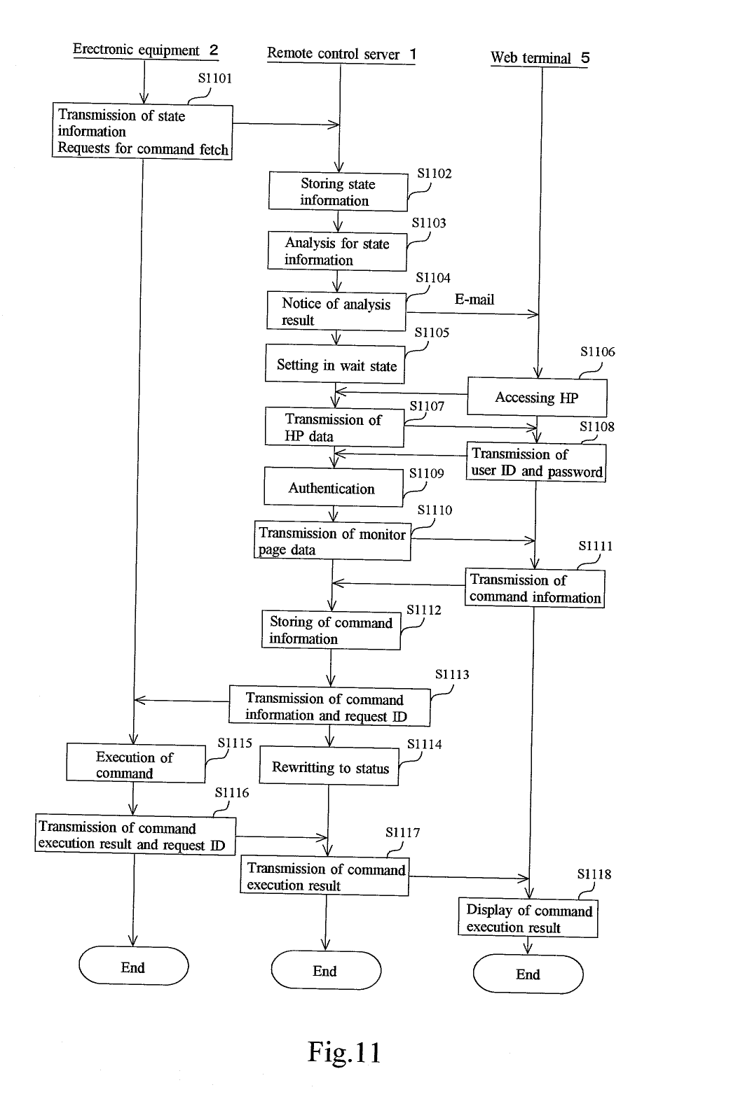

Next, making reference to FIG. 11, processing in the remote control system relating to embodiment aspect 3 is described.

First, from the electronic equipment 2, with predetermined timing, electronic equipment 2 state information and a command fetch request are passed through the firewall 4 via the internal network 7, to the remote control server 1 via the internet 6 (S1101). The remote control server 1 stores the state information in a prescribed area in the electronic equipment state database 122 by the controller 11 and the data collection means 13 (S1102).

Following thereupon, the stored state information is analyzed (S1103). This analysis is the same as that performed in step S1003 in embodiment aspect 2 of the invention and is not further described here. When, as a result of that analysis, information has been detected indicating a situation where the user should be contacted, notification to that effect is made by electronic mail to the web terminal 5 (S1104). In this embodiment aspect 3, together with this notification, the command fetch request (S1101) to this remote control server 1 is set in a wait state (S1105). Here, the setting to the wait state is done in cases where command information in an untransmitted condition corresponding to the command fetch request (S1101) has not been stored. When the command has been stored, that command is transmitted immediately as a response to the command fetch request (S1101).

Let it be assumed that, after that, the user wished to operate the electronic equipment 2 in his or her home. First, using the web terminal 5, the user accesses a homepage on this remote control system (S1106). The remote control server 1, in response to that access request, reads out HTML data for the designated homepage from the memory 12, and transmits those data to the web terminal 5 via the internet 6 (S1107). The web terminal 5 displays that homepage on that display by the browser. The user operates the web terminal 5, and enters and transmits the user ID and password (S1108). Authentication information relating to that user ID and password is transmitted to the remote control server 1 via the internet 6. The remote control server 1 receives that authentication information, launches an authentication program, and performs authentication processing (S1109). When it has been judged, as a result of the authentication process, that the password is appropriate to the received user ID, monitor page data are transmitted to the web terminal 5 (S1110). The web terminal 5 receives those monitor page data and displays them on the display. The display is made as in the screen example shown in FIG. 8. When the user inputs a command and clicks on the transmission button, command information is transmitted from the web terminal 5 to the remote control server 1 (S1111).

The remote control server 1 receives the command information and stores it in memory area assigned to that user in the command database 123 (S1112).

Next, command information is read out from the command database 123 and transmitted, together with the request ID, from the remote control server 1 to the electronic equipment 2 (S1113). Here, this request ID is ID information issued by the remote control server 1 in order to unequivocally distinguish operation command requests originated by the web terminal 5. The remote control server 1 always issues different ID information for each received request. That is, even when they are operation command requests from the same web terminal 5, in response to requests generated with different timing, the remote control server 1 issues different ID information each time those are received. The same is true of request IDs thereafter. At this time, the signal containing that information is a response to the command fetch request (S101) set in the wait state (S1105), wherefore it can pass through the firewall 4.

At the remote control server 1, when the transmission of the command information is finished, the data for the condition (status) of the command in the command database 123 are rewritten to data indicating “transmitted” (S1114). At the electronic equipment 2, that command information and request ID are received and the command is executed (S1115).

The electronic equipment 2, when a command is executed, transmits the results of that command execution and the request ID received together with the command information to the remote control server 1 (S1116). The command execution results will differ according to the type of the command, and will be, for example, such as information on whether the command was executed or not, or image information for an image fetch command. The remote control server 1 receives those command execution results and request ID. The remote control server 1 then specifies a command information transmission request corresponding to the request ID, and transmits the command execution results to the web terminal 5 as the response thereto (S1117). The web terminal 5 receives the command execution results and displays them (S1118).

At this time, furthermore, a time out function may also be provided in the remote control server 1. This time out function starts a timer in response to the transmission of a request ID (S1113), and determines whether or not command execution results corresponding to that request ID were received from the electronic equipment 2 within a certain time. In cases where the command execution results cannot be received within the certain time, notification to that effect is made to the web terminal 5.

Thus, in the remote control system relating to this embodiment aspect 3, since the command fetch request is set in the wait state, it makes possible to promptly transmit command information from the user to the electronic equipment. Furthermore, since the user can promptly receive the execution results at the electronic equipment, in particular, when it has been determined by analyzing condition information that there is a problem and notification of the analysis results has been made to the user's terminal, the user can promptly send the appropriate command information and receive the execution results in order to solve the problem.

Embodiment Aspect 4 of the Invention

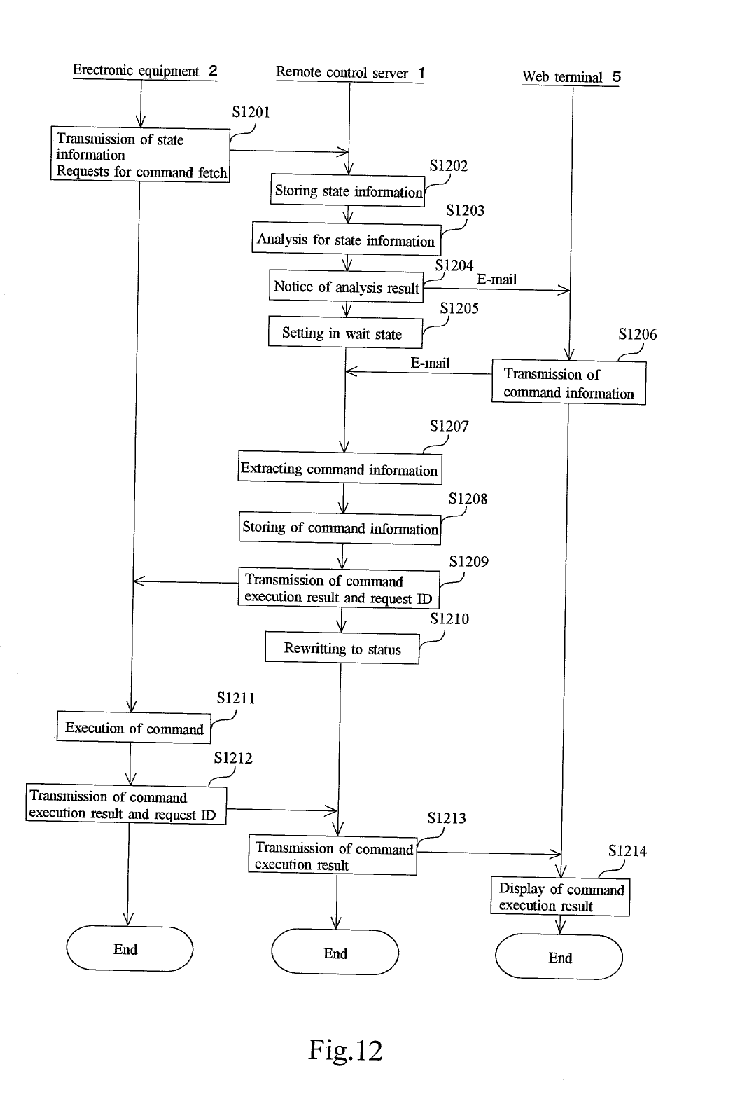

Next, making reference to FIG. 12, processing in the remote control system relating to embodiment aspect 4 is described.

First, from the electronic equipment 2, with predetermined timing, electronic equipment 2 state information and a command fetch request are passed through the firewall 4 via the internal network 7, to the remote control server 1 via the internet 6 (S1201). The remote control server 1 stores the state information in a prescribed area in the electronic equipment state database 122 by the controller 11 and the data collection means 13 (S1202).

Following thereupon, the stored state information is analyzed (S1203). This analysis is the same as that performed in step S1003 in embodiment aspect 2 of the invention and is not further described here.

When, as a result of that analysis, information has been detected indicating a situation where the user should be contacted, notification to that effect is made by electronic mail to the web terminal 5 (S1204). In this embodiment aspect 3, together with this notification, the command fetch request (S1201) to this remote control server 1 is set in a wait state (S1205). Here, the setting to the wait state is done in cases where command information in an untransmitted condition corresponding to the command fetch request (S1201) has not been stored. In cases where a command has been stored, that command is transmitted immediately as a response to the command fetch request (S1201).

Let it be assumed that, after that, the user wished to operate the electronic equipment 2 in his or her home. Using the web terminal 5, the user adds command information to the electronic mail that will be the reply to the electronic mail transmitted in step S1204, and transmits that electronic mail (S1206).

The remote control server 1 extracts the command information from that electronic mail and processes it (S1207), and stores it in memory area assigned to that user in the command database 123 by the command transmission means 14 (S1208). Then, command information is read out from the command database 123 and transmitted, together with the request ID, from the remote control server 1 to the electronic equipment 2 (S1209). At the remote control server 1, when the transmission of the command information is finished, the data for the condition (status) of the command in the command database 123 are rewritten to data indicating “transmitted” (S1210). At the electronic equipment 2, that command information and request ID are received and the command is executed (S1211).

The electronic equipment 2, when a command is executed, transmits the results of that command execution and the request ID received together with the command information to the remote control server 1 (S1212). The command execution results will differ according to the type of the command, and will be, for example, such as information on whether the command was executed or not, or image information for an image fetch command. The remote control server 1 receives those command execution results and request ID. The remote control server 1 then specifies a command information transmission request corresponding to the request ID, and transmits the command execution results to the web terminal 5 as the response thereto (S1213). The web terminal 5 receives the command execution results and displays them (S1214).

At this time, furthermore, a time out function may also be provided in the remote control server 1. This time out function starts a timer in response to the transmission of a request ID (S1212), and determines whether or not command execution results corresponding to that request ID were received from the electronic equipment 2 within a certain time. In cases where the command execution results cannot be received within the certain time, notification to that effect is made to the web terminal 5.

Thus, in the remote control system relating to this embodiment aspect 4, particular provision is made so that command information from the user in response to the notification of the analysis results is received by electronic mail, wherefore, for the user, command information can be transmitted extremely easily.

Embodiment Aspect 5 of the Invention

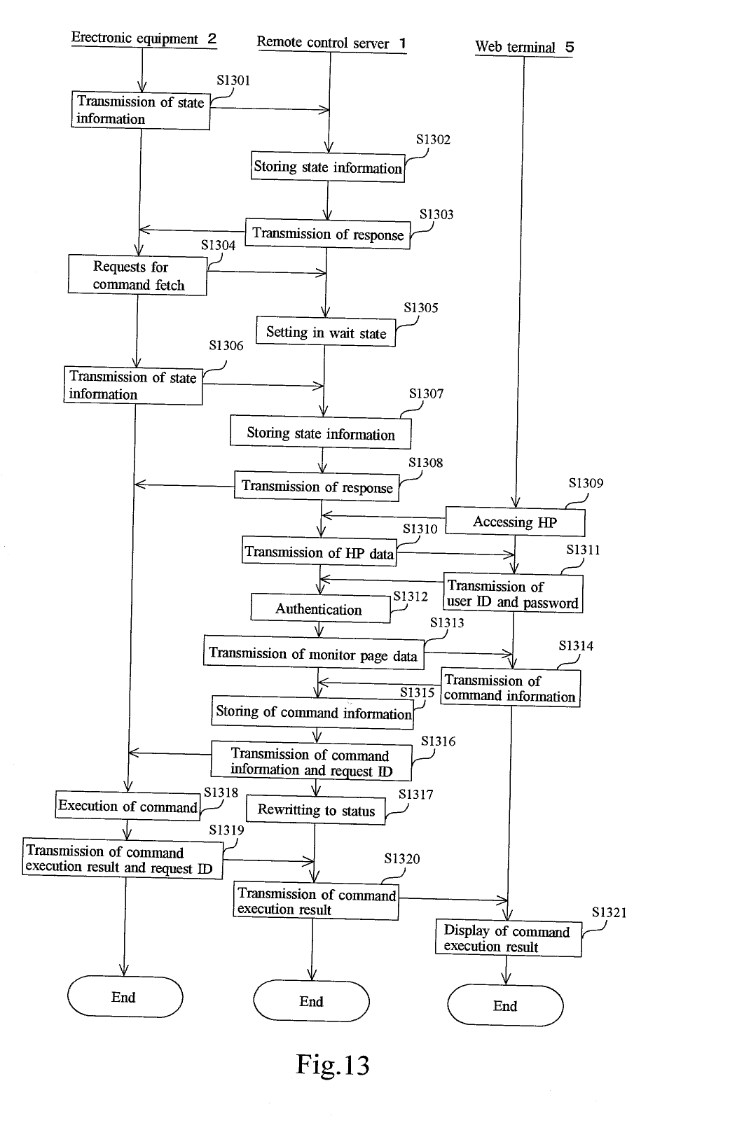

Next, making reference to FIG. 13, processing in the remote control system relating to embodiment aspect 5 is described.

First, from the electronic equipment 2, with predetermined timing, electronic equipment 2 state information is passed through the firewall 4 via the internal network 7, to the remote control server 1 via the internet 6 (S1301). The remote control server 1 stores the state information in a prescribed area in the electronic equipment state database 122 by the controller 11 and the data collection means 13 (S1302). Then, the remote control server 1 transmits a response to that state information transmission to the electronic equipment 2 (S1303).

Also, when a command fetch request has been transmitted from the electronic equipment 2 (S1304), the remote control server 1 sets that command fetch request in the wait state (S1305). Here, the setting to the wait state is done in cases where command information in an untransmitted condition corresponding to the command fetch request (S1304) has not been stored. In cases where a command has been stored, that command is transmitted immediately as a response to the command fetch request (S1304).

After that, state information on the electronic equipment 2 is transmitted from the electronic equipment 2 with prescribed timing, so as to pass via the internal network 7 through the firewall 4, and then via the internet 6 to the remote control server 1 (S1306). The remote control server 1 stores the state information in prescribed area in the electronic equipment state database 122 by the controller 11 and the data collection means 13 (S1307). Then the remote control server 1 transmits a response to that state information transmission (S1306) to the electronic equipment 2 (S1308).

Let it be assumed that, after that, the user wished to operate the electronic equipment 2 in his or her home. First, using the web terminal 5, the user accesses a homepage on this remote control system (S1309). The remote control server 1, in response to that access request, reads out HTML data for the designated homepage from the memory 12, and transmits those data to the web terminal 5 via the internet 6 (S1310). The web terminal 5 displays that homepage on that display by the browser. The user operates the web terminal 5, and enters and transmits the user ID and password (S1311). Authentication information relating to that user ID and password is transmitted to the remote control server 1 via the internet 6. The remote control server 1 receives that authentication information, launches an authentication program, and performs authentication processing (S1312). When it has been judged, as a result of the authentication process, that the password is appropriate to the received user ID, monitor page data are transmitted to the web terminal 5 (S1313). The web terminal 5 receives those monitor page data and displays them on the display. The display is made as in the screen example shown in FIG. 8. When the user inputs a command and clicks on the transmission button, command information is transmitted from the web terminal 5 to the remote control server 1 (S1314).

The remote control server 1 receives the command information, stores it, together with the request ID, in memory area assigned to that user in the command database 123 (S1315), and transmits it as a response to the command fetch request (S1304) that was set to the wait state (S1305) to the electronic equipment 2 (S1316). At that time, the signal containing that information is a response to the command fetch request (S1304), and therefore can pass through the firewall 4.

At the remote control server 1, when the transmission of the command information is finished, the data for the condition (status) of the command in the command database 123 are rewritten to data indicating “transmitted” (S1317). At the electronic equipment 2, that command information and request ID are received and the command is executed (S1318).

The electronic equipment 2, when a command is executed, transmits the results of that command execution and the request ID received together with the command information to the remote control server 1 (S1319). The command execution results will differ according to the type of the command, and will be, for example, such as information on whether the command was executed or not, or image information for an image fetch command. The remote control server 1 receives those command execution results and request ID. The remote control server 1 then specifies a command information transmission request corresponding to the request ID, and transmits the command execution results to the web terminal 5 as the response thereto (S1320). The web terminal 5 receives the command execution results and displays them (S1321).

At this time, furthermore, a time out function may also be provided in the remote control server 1. This time out function starts a timer in response to the transmission of a request ID (S1316), and determines whether or not command execution results corresponding to that request ID where received within a certain time. In cases where the command execution results cannot be received within the certain time, notification to that effect is made to the web terminal 5.

Thus, in the remote control system relating to this embodiment aspect 5, in particular, since the response to the command fetch request is set in the wait state, it makes possible to promptly transmit command information from the user to the electronic equipment, and, furthermore, the user can promptly receive the execution results at the electronic equipment.

Embodiment Aspect 6 of the Invention

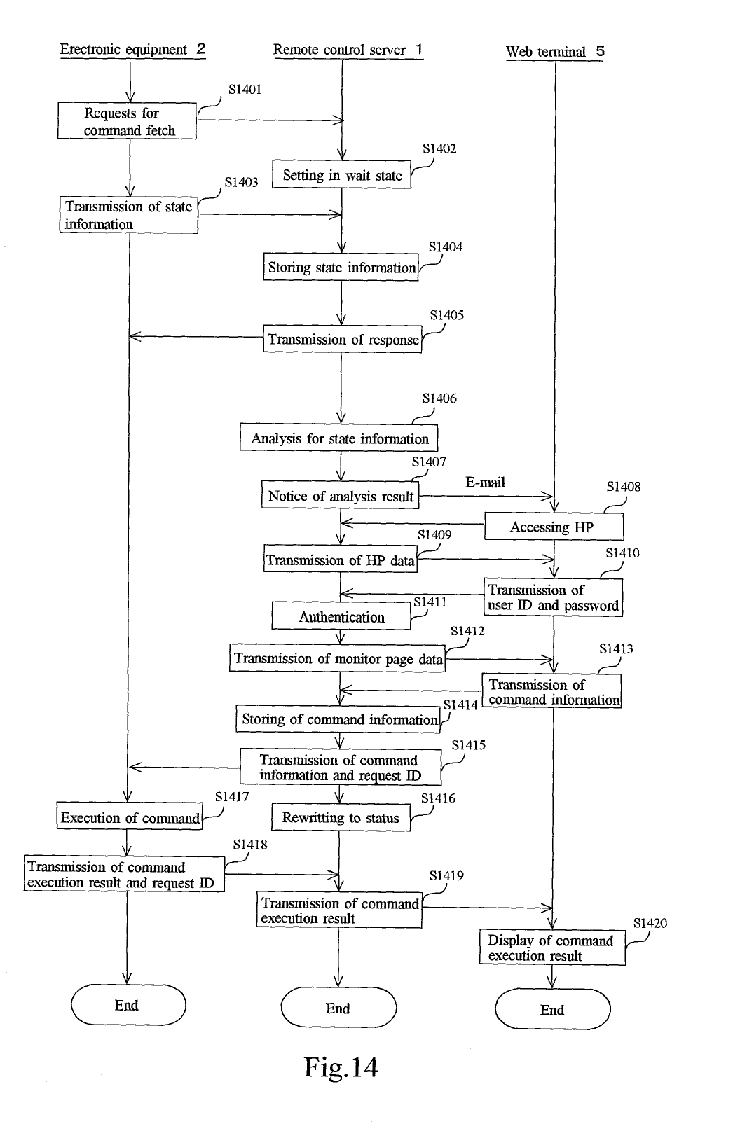

Next, making reference to FIG. 14, processing in the remote control system relating to embodiment aspect 6 is described.

First, a command fetch request is transmitted from the electronic equipment 2 (S1401), and the remote control server 1 sets that command fetch request to the wait state (S1402). Here, the setting to the wait state is done in cases where command information in an untransmitted condition corresponding to the command fetch request (S1401) has not been stored. In cases where a command has been stored, that command is transmitted immediately as a response to the command fetch request (S1401).

After that, state information on the electronic equipment 2 is transmitted from the electronic equipment 2 with predetermined timing to the remote control server 1 (S1403). The remote control server 1 stores the state information in prescribed area in the electronic equipment state database 122 by the controller 11 and the data collection means 13 (S1404). Then the remote control server 1 transmits a response to that state information transmission to the electronic equipment 2 (S1405).

Next, the remote control server 1 analyzes the state information stored in the electronic equipment state database 122 (S1406). This analysis is the same as that executed in step S1003 in embodiment aspect 2 of the invention, and so is not further described here. When, as a result of the analysis, information has been detected which indicates a situation concerning which the user should be contacted, notification to that effect is made by electronic mail to the web terminal 5 (S1407).

Let it be assumed that, after that, the user wished to operate the electronic equipment 2 in his or her home. First, using the web terminal 5, the user accesses a homepage on this remote control system (S1408). The remote control server 1, in response to that access request, reads out HTML data for the designated homepage from the memory 12, and transmits those data to the web terminal 5 via the internet 6 (S1409). The web terminal 5 displays that homepage on that display by the browser. The user operates the web terminal 5, and enters and transmits the user ID and password (S1410). Authentication information relating to that user ID and password is transmitted to the remote control server 1 via the internet 6. The remote control server 1 receives that authentication information, launches an authentication program, and performs authentication processing (S1411). When it has been judged, as a result of the authentication process, that the password is appropriate to the received user ID, monitor page data are transmitted to the web terminal 5 (S1412). The web terminal 5 receives those monitor page data and displays them on the display. The display is made as in the screen example shown in FIG. 8. When the user inputs a command and clicks on the transmission button, command information is transmitted from the web terminal 5 to the remote control server 1 (S1413).

The remote control server 1 receives the command information, stores it, together with the request ID, in memory area assigned to that user in the command database 123 (S1414), and transmits it as a response to the command fetch request (S1401) that was set to the wait state (step S1402) to the electronic equipment 2 (S1415). At that time, the signal containing that information is a response to the command fetch request (S1401), and therefore can pass through the firewall 4.

At the remote control server 1, when the transmission of the command information is finished, the data for the condition (status) of the command in the command database 123 are rewritten to data indicating “transmitted” (S1416). At the electronic equipment 2, that command information and request ID are received and the command is executed (S1417).

The electronic equipment 2, when a command is executed, transmits the results of that command execution and the request ID received together with the command information to the remote control server 1 (S1418). The command execution results will differ according to the type of the command, and will be, for example, such as information on whether the command was executed or not, or image information for an image fetch command. The remote control server 1 receives those command execution results and request ID. The remote control server 1 then specifies a command information transmission request corresponding to the request ID, and transmits the command execution results to the web terminal 5 as the response thereto (S1419). The web terminal 5 receives the command execution results and displays them (S1420).

At this time, furthermore, a time out function may also be provided in the remote control server 1. This time out function starts a timer in response to the transmission of a request ID (S1415), and determines whether or not command execution results corresponding to that request ID were received from the electronic equipment 2 within a certain time. In cases where the command execution results cannot be received within the certain time, notification to that effect is made to the web terminal 5.

Thus, in the remote control system relating to this embodiment aspect 6, the response to the command fetch request is set in the wait state, thus making it possible to promptly transmit command information from the user to the electronic equipment, and, furthermore, the user can promptly receive the execution results at the electronic equipment. Provision is made also so that the state information is analyzed, and notification of the analysis results is made to the user's terminal, wherefore the user can learn right away of the occurrence of a problem.

Embodiment Aspect 7 of the Invention

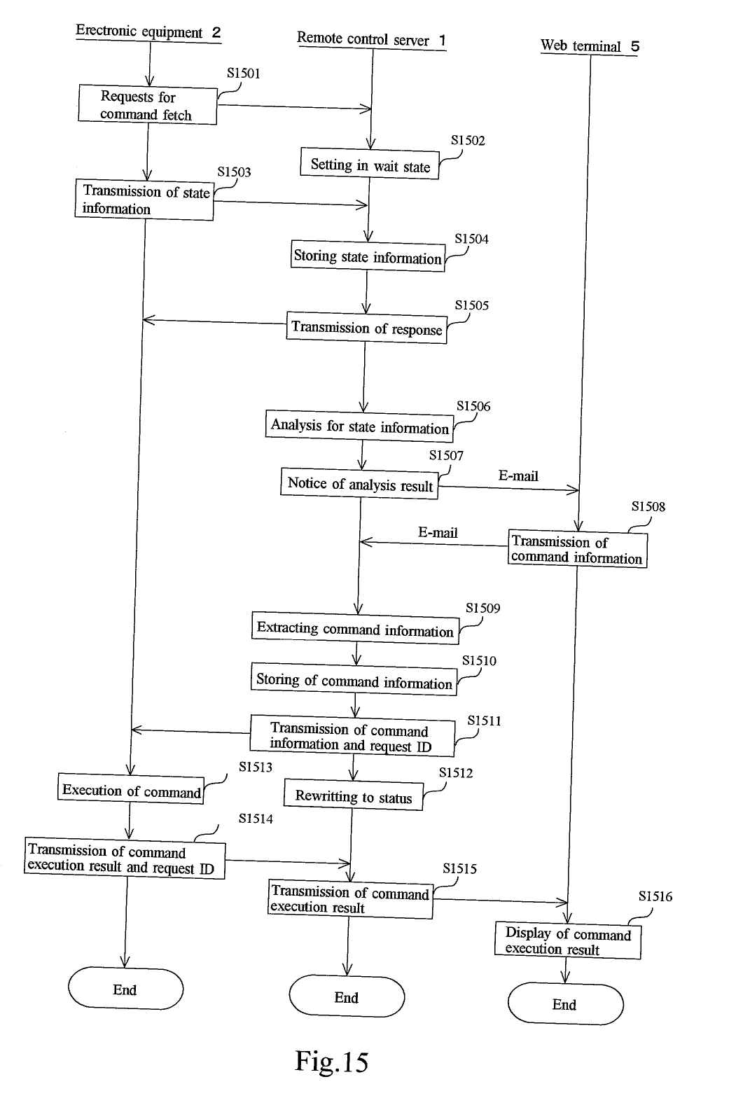

Next, making reference to FIG. 15, processing in the remote control system relating to embodiment aspect 7 is described.

First, a command fetch request is transmitted from the electronic equipment 2 (S1501), and the remote control server 1 sets that command fetch request to the wait state (S1502). Here, the setting to the wait state is done in cases where command information in an untransmitted condition corresponding to the command fetch request (S1501) has not been stored. In cases where a command has been stored, that command is transmitted immediately as a response to the command fetch request (S1501).

After that, state information on the electronic equipment 2 is transmitted from the electronic equipment 2 with prescribed timing to the remote control server 1 (S1503). The remote control server 1 stores the state information in prescribed area in the electronic equipment state database 122 by the controller 11 and the data collection means 13 (S1504). Then the remote control server 1 transmits a response to that state information transmission to the electronic equipment 2 (S1505).

Next, the remote control server 1 analyzes the state information stored in the electronic equipment state database 122 (S1506). This analysis is the same as that executed in step S1003 in embodiment aspect 2 of the invention, and so is not further described here. When, as a result of the analysis, information has been detected which indicates a situation concerning which the user should be contacted, notification to that effect is made by electronic mail to the web terminal 5 (S1507).

Let it be assumed that, after that, the user wished to operate the electronic equipment 2 in his or her home. Using the web terminal 5, the user adds command information to the electronic mail that will be the reply to the electronic mail transmitted in step S1507, and transmits that electronic mail (S1508).

The remote control server 1 extracts and processes command information from that electronic mail (S1509), stores it in memory area assigned to that user in the command database 123 (S1510), and transmits it as a response to the command fetch request (S1501) that was set to the wait state (S1502), together with the request ID, to the electronic equipment 2 (S1511). At that time, the signal containing that information is a response to the command fetch request (S1501), and therefore can pass through the firewall 4.

At the remote control server 1, when the transmission of the command information is finished, the data for the condition (status) of the command in the command database 123 are rewritten to data indicating “transmitted” (S1512). At the electronic equipment 2, that command information and request ID are received and the command is executed (S1513).

The electronic equipment 2, when a command is executed, transmits the results of that command execution and the request ID received together with the command information to the remote control server 1 (S1514). The command execution results will differ according to the type of the command, and will be, for example, such as information on whether the command was executed or not, or image information for an image fetch command. The remote control server 1 receives those command execution results and request ID. The remote control server 1 then specifies a command information transmission request corresponding to the request ID, and transmits the command execution results to the web terminal 5 as the response thereto (S1515). The web terminal 5 receives the command execution results and displays them (S1516).

At this time, furthermore, a time out function may also be provided in the remote control server 1. This time out function starts a timer in response to the transmission of a request ID (S1511), and determines whether or not command execution results corresponding to that request ID were received from the electronic equipment 2 within a certain time. In cases where the command execution results cannot be received within the certain time, notification to that effect is made to the web terminal 5.

Thus, in the remote control system relating to this embodiment aspect 7, the response to the command fetch request is set in the wait state, thus making it possible to promptly transmit command information from the user to the electronic equipment. Provision is made also so that the state information is analyzed, and the analysis results are notified to the user's terminal, wherefore the user can learn right away of the occurrence of a problem. Particular provision is made so that command information from the user in response to the notification of the analysis results is received by electronic mail, wherefore, for the user, command information can be transmitted extremely easily.

Other Embodiment Aspects

In the remote control systems relating to embodiment aspects 5, 6, and 7 of the invention, described in the foregoing, a wait state is set for the command fetch request. However, in cases where, for example, the firewall 4 is timer-controlled, and a response to a request does not come back after a certain time t has elapsed, there will be cases where setting is made so that the passage of that response is restricted. In such cases, command information transmitted from the web terminal 5 cannot be transmitted immediately to the electronic equipment 2. Thereupon, if provision is made so that timer control information for the firewall 4 is input to that electronic equipment 2, and so that the time interval for the command fetch request from the electronic equipment 2 becomes equal to or less than that certain time t, this problem can be resolved. Alternatively, the problem may be resolved by having the remote control server 1 obtain the timer control information of the firewall 4, and direct the electronic equipment 2 to transmit command fetch requests at an interval equal to or less than that certain time t.

Provision may be made so that state information from the electronic equipment 2 is transmitted with a certain periodicity to the remote control server 1, but provision may also be made so that, after a command information transmission from the web terminal 5 has been received, when the next request data are transmitted to the remote control server 1, the latest data are appended to those request data. Provision may also be made so that command information is transmitted as history data after adding thereto the address of the individual who transmitted it.

Various protocols can be employed as the communication protocol between the remote control server 1 and the electronic equipment 2, such as HTTP, mail, and FTP.

In the remote control system relating to the present invention, moreover, provision may be made so that the party operating the system invoices each user for a fee, either on a monthly basis or according to information volume, such as the number of commands or number of packets, and each user pays that fee by a settlement method previously registered.

Provision may also be made so that the operator of such remote control system implements additional services, besides those described in the foregoing, such as services allowing inquiries to be made when a problem in the system, such as with the firewall, has occurred, or accepting proposals or implementing cause analysis or the like.

Provision may be made, furthermore, so that the remote control server 1 obtains such information as electricity, gas, and water volumes from the electronic equipment 2, as state information, and, based on that information so obtained, compares past utilization volume data, prepares improvement plans, and makes notification thereof to the user to the web terminal 5 or the like. In particular, by making comparisons with past utilization volume data, it is possible to learn of trends indicating whether too much of such utilities is being used or the like.

In the examples described in the foregoing, moreover, it is possible to store the various types of programs installed in the computer hard disk or memory configuring the remote control server in a memory medium, and it is also possible that such be transmitted via communication means. Here, such memory media include, for example, flexible disks, hard disks, magnetic disks, optical-magnetic disks, CD-ROMs, DVDs, ROM cartridges, RAM memory cartridges equipped with battery backup, flush memory cartridges, and non-volatile RAM cartridges. The communication means includes means such as hard-line communication means such as telephone lines or the like, and radio communication means such as microwave links or the like, and also include the internet.

Based on the present invention, a remote control system can be provided wherewith it is possible to easily effect the remote control of electronic equipment connected through a firewall to the internet.

While preferred embodiments of the invention have been described using specific terms, such description is for illustrative purposes only, and it is to be understood that changes and variations may be made without departing from the spirit or scope of the following claims.

What is claimed is:

1. A remote control system for controlling remotely electronic equipment connected via a firewall to an external network, comprising:
command information memory for storing command information transmitted from a user terminal via said external network; and
command information transmission means for receiving a command fetch request transmitted from said electronic equipment via said external network, reading out command information corresponding to that request from said command information memory, and transmitting said command information via said external network to said electronic equipment as a response to that command fetch request.

2. A remote control system for controlling remotely electronic equipment connected via a firewall to an external network, comprising:
wait state setting means for receiving a command fetch request from said electronic equipment via said external network, and setting a wait state for that command information; and
command information transmission means for receiving command information transmitted from a user terminal via said external network, and transmitting that command information to said electronic equipment as a response to said command fetch request.

3. The remote control system according to claim 1 or 2, further having: state information memory for receiving and storing state information transmitted from said electronic equipment via said external network; and state information transmission means for transmitting state information stored in said state information memory to said user terminal.

4. The remote control system according to claim 1 or 2, further having: state information memory means for receiving and storing state information transmitted from said electronic equipment via said external network; state information analysis means for analyzing state information stored in said state information memory means; and analysis results transmission means for transmitting analysis results from said state information analysis means to said user terminal.

5. The remote control system according to claim 4, wherein: said analysis results transmission means transmits said analysis results to said user terminal by electronic mail; and said command information transmission means extracts command information from electronic mail transmitted from said user terminal as reply to electronic mail transmitting said analysis results, and transmits that command information to said electronic equipment.

6. The remote control system according to claim 1 or 2, wherein said command information transmission means, in cases where information pertaining to command execution time period for said electronic equipment is contained in command information received from said user terminal, transmit that command information at a time corresponding to that command execution time period when that electronic equipment has no time control function.

7. The remote control system according to claim 1 or 2, further comprising means for receiving command execution results information transmitted from said electronic equipment via said external network, and transmitting that information to said user terminal.

8. A remote control method for controlling remotely electronic equipment connected via a firewall to an external network, comprising the steps of:
storing command information transmitted from a user terminal via said external network;
receiving a command fetch request transmitted from said electronic equipment via said external network; and
reading out command information corresponding to that request and transmitting said information via said external network to said electronic equipment as a response to that command fetch request.

9. A remote control method for controlling remotely electronic equipment connected via a firewall to an external network, comprising the steps of:
receiving a command fetch request from said electronic equipment via said external network, and setting a wait state for that command information; and
receiving command information transmitted from a user terminal via said external network, and transmitting that command information to said electronic equipment as a response to said command fetch request.

10. The remote control method according to claim 8 or 9, further comprising the step of receiving command execution results information transmitted from said electronic equipment via said external network, and transmitting that information to said user terminal.

11. A remote control program product for controlling remotely electronic equipment connected via a firewall to an external network, wherein:
said remote control program product causes a computer to perform the steps of:
storing command information transmitted from a user terminal via said external network;
receiving a command fetch request transmitted from said electronic equipment via said external network; and
reading out command information corresponding to that request and transmitting said information via said external network to said electronic equipment as a response to that command fetch request.

12. A remote control program product for controlling remotely electronic equipment connected via a firewall to an external network, wherein:
said remote control program products causes a computer to perform the steps of:
receiving a command fetch request from said electronic equipment via said external network, and setting a wait state for that command information; and
receiving command information transmitted from a user terminal via said external network, and transmitting that command information to said electronic equipment as a response to said command fetch request.

13. The remote control program product according to claim 11 or 12, further comprising the step of receiving command execution results information transmitted from said electronic equipment via said external network, and transmitting that information to said user terminal.
